(19) United States
(12) Patent Application Publication
(10) Pub. No.: US 2016/0171440 A1
(43) Pub. Date: Jun. 16, 2016

(54) METHOD AND SYSTEM FOR FREIGHT MANAGEMENT

(71) Applicant: Infosys Limited, Bangalore (IN)

(72) Inventors: Kolandaiswamy Antony Arokia Durai Raj, Pollachi (IN); Balasubramanian Kanagasabapathi, Erode (IN)

(21) Appl. No.: 14/965,215

(22) Filed: Dec. 10, 2015

(30) Foreign Application Priority Data
Dec. 12, 2014 (IN) 6279/CHE/2014

(51) Int. Cl. G06Q 10/08

(52) U.S. Cl. CPC G06Q 10/08355

(57) ABSTRACT

A system and a method for management of freight is disclosed. The method includes receiving (502) an input from a user. The input is mapped (504) with a network database and a route is calculated (506). The calculated route is displayed (508) to the user. An input in response to the calculated route is received (510). Based on the input, a list of route options is presented to the user (512). A response to the list of route options is collected (512). A result of the response to the list option is rendered to the user (514). A learning engine is updated based on the received input and collected response (516).

This application claims priority to India Patent Application No. 6279/CHE/2014, filed Dec. 12, 2014, the disclosure of which is hereby incorporated by reference in its entirety.

### FIELD OF TECHNOLOGY

The present disclosure relates generally to the field of freight transportation and in particular, to a system and method for efficiently managing freight transportation in a multi-mode distribution system.

### BACKGROUND

E-commerce has grown mammoth over years all around the world. However some shoppers search in market for buying daily home needs, groceries, accessories, computers, laptops, etc. There is a need for transporting these purchased items to shoppers' home. Many vendors offer home delivery but some of them do not. It can be difficult for the buyer to transport a particular product on their own. Today, technology allows the shoppers buy goods using a computing device. While the purchase has become easier for the shoppers, the vendors still need to ship goods to the purchaser. Most of the online purchases may have shipping charges added while purchasing goods. The shipping charges vary depending on shipping place and duration of shipping. The vendors need to manage the freight transit including the mode of transport used and the route followed for shipping.

Determining a route to transport freight from a source to a destination in a multi-node transport system is important and plays a vital role in overall service. There are many factors that influence the decision on generating a route for shipment of goods from the source to the destination. To name a few, type of transportation mode, hard constraints, soft constraints, cost effectiveness, availability of resources, meeting the requested delivery date, reliability of the service provider and the user preference. These factors play a vital role in deciding route for shipment. Today, a system to handle freight transit, considering all of these factors is needed.

### SUMMARY

In one aspect, a computer implemented method involves receiving an input request for a freight transit. The input request may be one of a freight information and a location information. The input request is matched with a network database. One or more routes are calculated in response to the matching. The one or more calculated routes are displayed on a computer system. An input is received in response to the one or more calculated routes, through a computing device. The input received in the response may be selection of the one or more calculated routes. A list of route options is presented based on the received input. One or more responses to the list of route options is collected. A result of the one or more responses to the list of route options is displayed. A learning engine is updated based on the received input and the In another aspect, a system for freight management is disclosed. The system includes, a route mapping server, a receiver, a mapper, a calculator, a display unit and an updater. The route mapping server handles a freight transit and is associated with a computer network. An input request for a freight transit is received through the receiver. The mapper maps the input request with a network database. One or more routes are calculated by the calculator in response to the mapping performed by the mapper. The display unit renders the one or more calculated routes on a computer system. A response to the one or more calculated routes is received by the receiver. Based on the response, a list of route options is displayed. One or more responses to the list of route options are received through the receiver. A result of the one or more responses to the list of route options is displayed on the display unit. The updater is configured to update a learning engine based on the received input and the collected response.

In an additional aspect, a computer implemented method for freight management is disclosed. The method includes receiving one or more preference of one or more factors from a user. Weight of the one or more factors are calculated based on the one or more preferences. The weight of the one or more factors may be calculated through one or more decision models. Based on the one or more preferences and the weight, a demand for a freight transit is predicted. The predicted demand is presented to the user.

The methods and the systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

Example embodiments are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one embodiment.

FIG. 2 is a block diagram illustrating a relationship between various modules of a system for freight management, according to one or more embodiments.

FIG. 3 is a flowchart, illustrating a method receiving freight transit order form a user in a system for freight management, according to one or more embodiments.

FIG. 4 is a flowchart, illustrating a method for predicting demand in a system for freight management, according to one or more embodiments.

FIG. 5 is a process flow diagram, illustrating a method for freight management, according to one or more embodiments.

FIG. 6 is a block diagram, illustrating a system for freight management, according to one or more embodiments.

FIG. 7 is a process flow diagram, illustrating a method for predicting demand in a system for freight management, according to one or more embodiments.

FIG. 8 is a block diagram, illustrating different modules constituting analytical engine of a system for freight management, according to one or more embodiments.

FIG. 9 is a block diagram, illustrating a connectivity of various modules of a system for freight management, according to one or more embodiments.

Other features of the present embodiments will be apparent from the accompanying drawings and from the detailed description that follows.

### DETAILED DESCRIPTION

Example embodiments, as described below, may be used to provide a method and/or a system to efficiently manage freight transportation in a multi-mode distribution system. Although the present embodiments have been described with reference to specific example embodiments, it will be evident that various modifications and changes may be made to these embodiments without departing from the broader spirit and scope of the various embodiments.

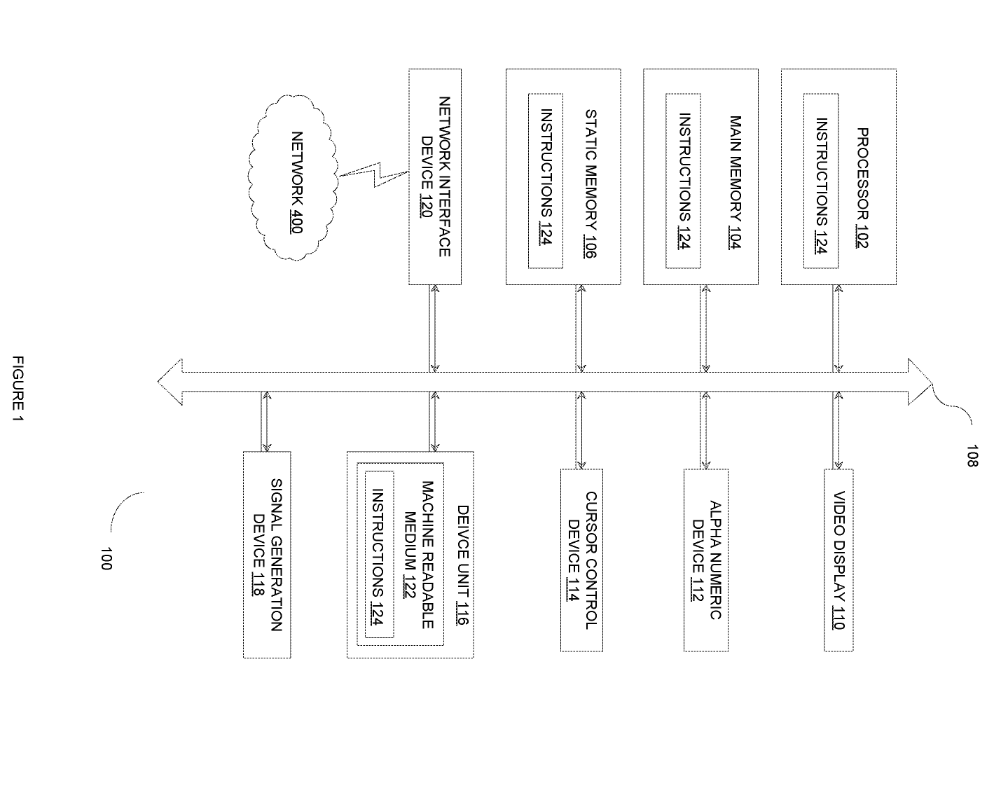

FIG. 1 is a diagrammatic representation of a data processing system capable of processing a set of instructions to perform any one or more of the methodologies herein, according to one embodiment. FIG. 1 shows a diagrammatic representation of machine in the example form of a computer system 100 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104 and/or within the processor 102 during execution thereof by the computer system 100, the main memory 104 and the processor 102 also constituting machine-readable media.

The instructions 124 may further be transmitted and/or received over a network 400 via the network interface device 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Exemplary embodiment of the present invention provides a system and/or method for freight management. The system and/or the method for freight management involves receiving an input request for freight transit. The input request may be one of a freight information and a location information. The input request may be matched with a network database. One or more routes may be calculated in response to the matching. The one or more calculated routes may be displayed on a computer system. An input may be received in response to the one or more calculated routes, through a computing device. The input received in response may be selection of the one or more calculated routes. A list of route options may be presented based on the received input. One or more responses to the list of route options may be collected. A result of the one or more responses to the list of route options may be displayed. A learning engine may be updated based on the received input and the collected response.

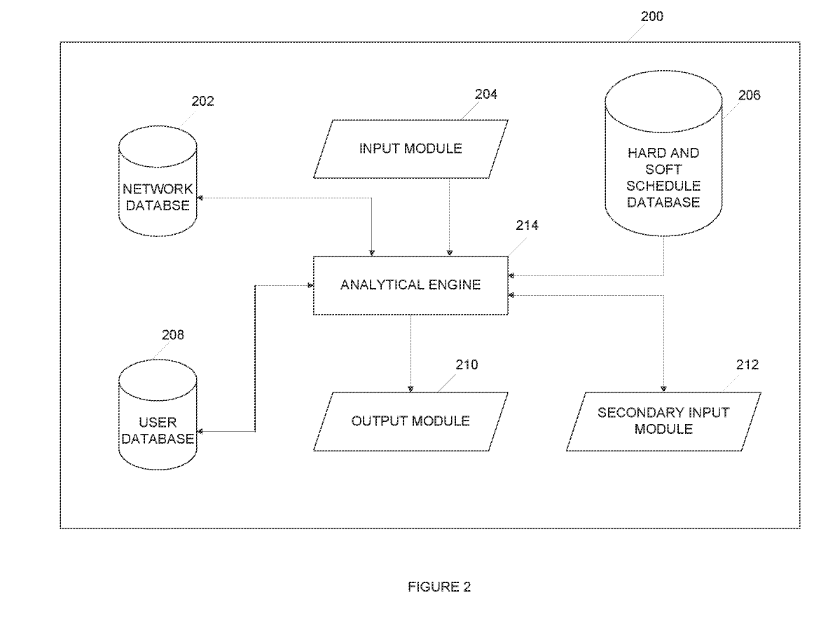

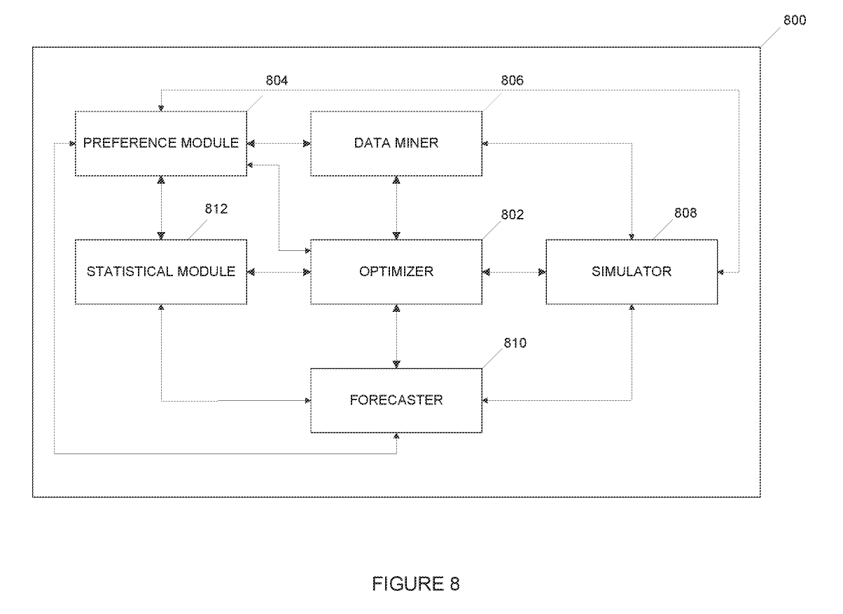

FIG. 2 is a block diagram, illustrating a relationship between various modules of a system for freight management, according to one or more embodiments. The system may include a network database 202, an input module 204, a hard and soft schedule database 206, a user database 208, an output module 210, a secondary input module 212, and an analytical engine 208. The network database 202 may be configured to store a freight transit route information. The freight transit route information may be, but not limited to information of one or more of: road networks, sea networks, rail networks, airway networks, details of loading and unloading locations, list of origin and destination (OD) pairs, types of service available, list of service providers, distance between OD pair, service available between OD pair, cost of transportation between OD pair, tax and regulations of OD pair, and/or availability of facilities at different locations. The input module 204 may be configured to receive an input from a user and/or a computing system. The hard and soft schedule database 206 may be configured to store a schedule for availability of resources. The resources may be, but not limited to driving unit, cranes, containers, man power and material. The driving unit may be, but not limited to locomotive engines, vessels, trucks, and airplanes. The containers may be of different types based on dimensions and/or capabilities. The containers may be, but not limited to freezers, tanks and tunnels. The user database 208, may be configured to store an information of the user. The output module 210, may be configured to render an output to the user. The secondary input module 212, may be configured to receive an input from the user and/or the computing system. The secondary input module 212, may be further configured to receive one or more inputs to a rendered output by the output module 210. The network database 202, the input module 204, the hard and soft schedule database 206, the user database 208, the output module 210, the secondary input module 212, may be communicatively coupled with the analytical engine 214. The input module 204 and the secondary input module 212 may be configured to receive the information from the user. The received information may be one or more of: user profiles, user preferences, origin and destination for shipment, date of shipment, desirable delivery date, preferred service provider, type of container required, safety constraints, transit constraints, cost constraints, service quality constraints, number of possible routes, and/or feedback about the routes. The analytical engine 214, may be configured to host different modules to solve one or more complex business problems. The analytical engine 214, is described in FIG. 8.

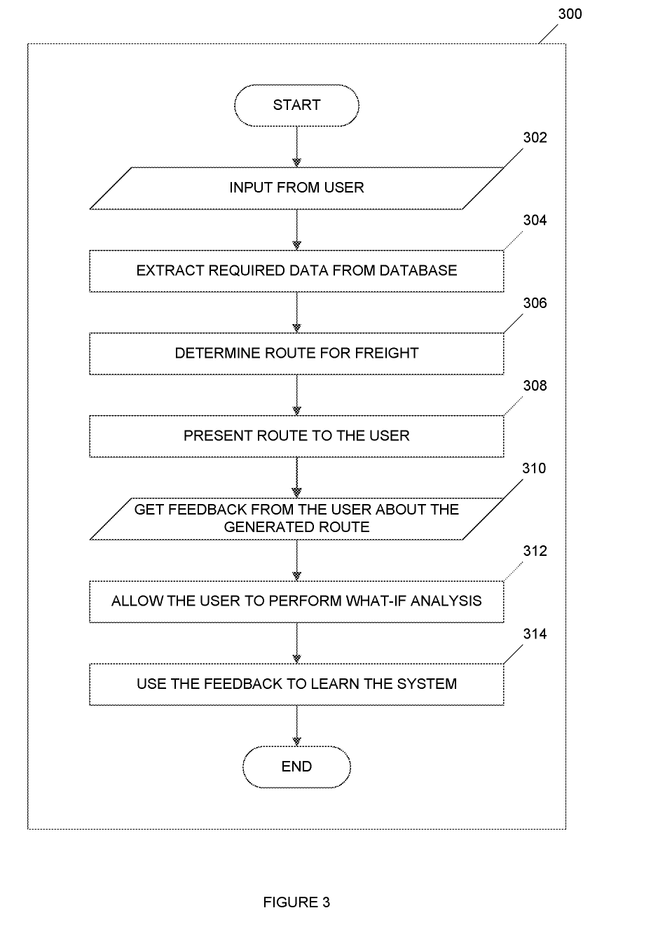

FIG. 3 is a flowchart, illustrating a method for receiving one or more freight transit orders from a user in a system for freight management, according to one or more embodiments. An input may be received from a user, as in step 302. The input may be to initialize a freight transit. The input may include, but not limited to one or more of: user profiles, user preferences, origin and destination for shipment, date of shipment, desirable delivery date, preferred service provider, type of containers required, safety constraints, transit constraints, cost constraints, service quality constraints, selection of possible routes, and/or feedback about the routes. A data of the user may be extracted from a user database, as in step 304. The user database may be configured to store an information of one or more users across globe. The user may enter required data for purchase of freight and various information required for the freight transit. One or more routes for the freight transit may be determined, as in step 306. The one or more routes determined in the step 306 may be presented to the user through a display unit, as in step 308. The user may select one route of the one or more routes for the freight transit. A feedback about the selected route may be received from the user, as in step 310. The feedback may be received through a user interface. The feedback may be, but not limited to questionnaires answered by the user and text to describe the route. In an exemplary embodiment, the feedback may be received through voice input. The user may perform what-if analysis by selecting different parameters for the freight transit, as in step 312. A learning engine may be updated based on the feedback, as in step 314.

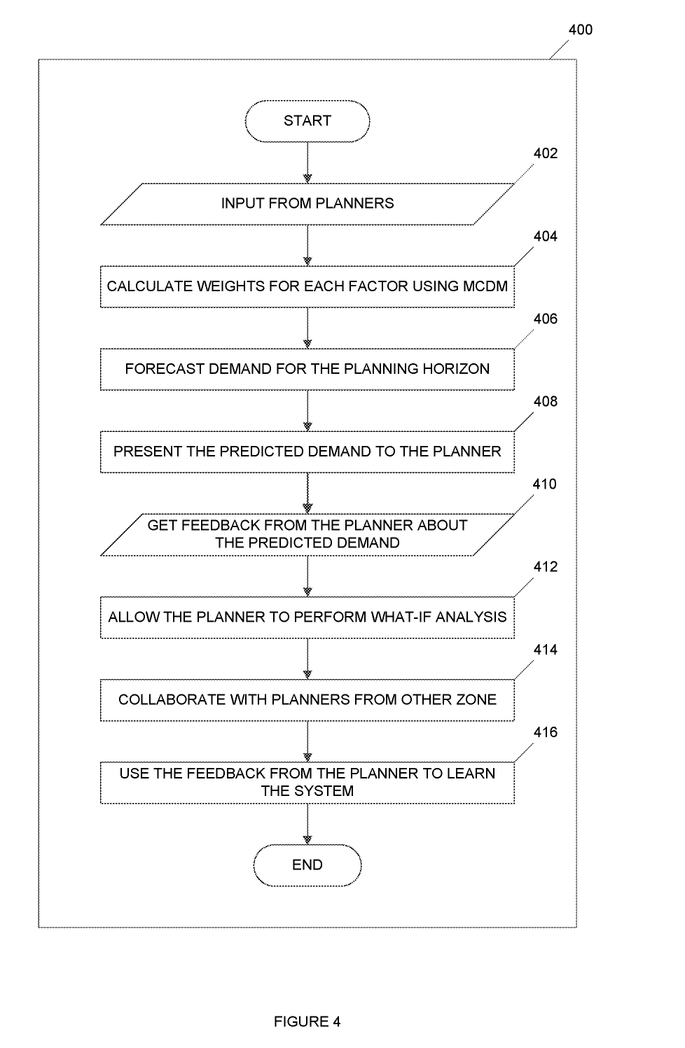

FIG. 4 is a flowchart, illustrating a method for predicting demand in a system for freight management, according to one or more embodiments. A user may purchase a freight and the planner may plan various ways to transit the freight. A planner may evaluate a service provider and/or a user, based on a set of criterion. An input may be received from the planner, as in step 402. The input may be, but not limited to selection of freight transit order placed by a one or more users, planner profiles, planner preferences, planning horizon, collaborative planning data and comments, number of possible routes, and a feedback from the planner. One or more factors and a preference(s) of the one or more factors may be received from the planner. A weight for one or more factors may be calculated, as in step 404. The one or more factors may be, but not limited to availability of different modes of transport, demand for freight, traffic in the network, cost effectiveness, shortage of containers, dead movement of empty containers and availability of different resources. A multi-criteria decision-making models (MCDM) may be employed in quantifying the weight of the factors. An analytical hierarchy process (AHP) may be chosen as one of the MCDM models. The MCDM models may use relative preferences received from one or more planners over a set of factors. The relative preference may be used to arrive at the weight of the one or more factors.

Demand for planning the horizon may be forecasted based on the weight of the one or more factors, as in step 406. The demand may be forecasted at aggregate level for preferences but not limited to location, the planned horizon, and/or the service providers. The planned horizon may be yearly, half-yearly, quarterly, monthly, and/or weekly. The demand, predicted in the step 406 may be presented to the planner, as in step 408. A feedback may be received from the planner on the predicted demand, as in step 410. The planner may be allowed to simulate various scenarios and may perform what-if analysis by selecting one or more parameters, as in step 412. The planner may be collaborated with one or more planners from various zones of the world, as in step 414. The feedback from the planner may be used to update learning engine, as in step 416.

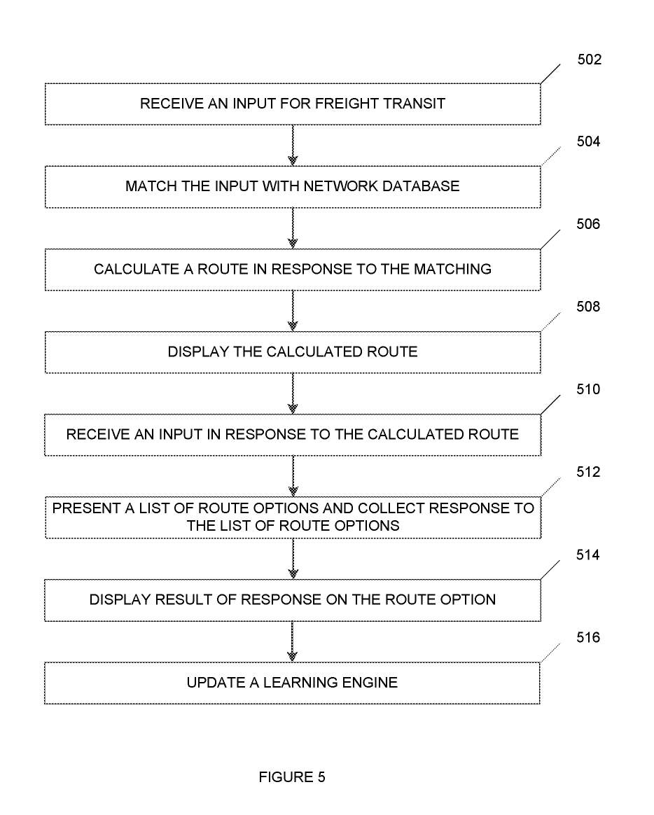

FIG. 5 is a process flow diagram, illustrating a method for freight management, according to one or more embodiments. An input request for freight transit may be received from a user, as in step 502. The input request may be a freight information and/or a location information. The input request may be matched with a network database, as in step 504. The network database may be configured to store a freight transit route information. The freight transit route information may be, but not limited to information of one or more of: road networks, sea networks, rail networks, airway networks, details of loading and unloading locations, list of origin and destination (OD) pairs, types of service available, a list of service providers, distance between OD pair, service available between OD pair, cost of transportation between OD pair, tax and regulations of OD pair, and/or availability of facilities at different locations. One or more routes in response to the matching performed in the step 504 may be calculated, as in step 506. The one or more routes calculated in the step 506 may be displayed on a computer system, as in step 508. The one or more routes calculated in the step 506 may be routes between the source location and the destination (delivery) location of the freight transit. The one or more routes may be calculated using a weighted function represented as:

$$Z = {\sum }_{i = 1}^{I} {W}_{i} \times {NX}_{i}$$

where,
Z is a weighted objective function;
I is a number of factors;
Wᵢ is a weight for each factor; and
NXᵢ is the normalized value of each factor.

An input in response to the calculated one or more routes may be received by the user through a computing device, as in step 510. The input received in the step 510 may be selection of the calculated one or more routes.

Based on the selection of the calculated one or more routes in the step 510, a list of route options may be presented to the user, as in step 512. One or more responses to the list of route options may be collected, as in the step 512. The one or more responses collected in the step 512 may be selection of a route option in the list of route options. The list of route options may be, but not limited to one or more airways, roadways, a rail routes and/or sea routes. Based on the one or more responses to the list of route options in the step 512, a result may be displayed on a display unit, as in the step 514. The result of the step 512, may be, but not limited to transit charge of a route option selected by the user, expected delivery date, and payment information. A learning engine may be updated based on the received input and the collected response, as in step 516.

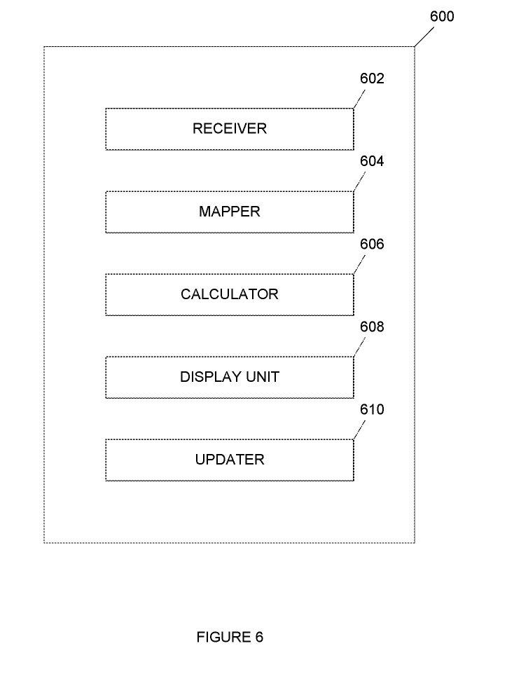

FIG. 6 is a block diagram, illustrating a system for freight management, according to one or more embodiments. The system for freight management may include a receiver 602, a mapper 604, a calculator 606, a display unit 608, and an updater 610. The receiver 602 may be configured to receive an input for freight transit. The input request may be a freight information and/or a location information. The mapper 604 may be configured to map the input request with a network database. The network database may be configured to store a freight transit route information. The freight transit route information may be, but not limited to information of one or more of: road networks, sea networks, rail networks, airway networks, details of loading and unloading locations, list of origin and destination (OD) pairs, types of service available, list of service providers, distance between OD pair, service available between OD pair, cost of transportation between OD pair, tax and regulations of OD pair, and/or availability of facilities at different locations. The calculator 606, may be configured to calculate one or more routes in response to the mapping. The calculated one or more routes may be various routes between a source location and a destination (delivery) location of the freight transit. The one or more routes may be calculated using a weighted function represented as:

$$Z = {\sum }_{i = 1}^{I} {W}_{i} \times {NX}_{i}$$

where,
Z is a weighted objective function;
I is a number of factors;
Wᵢ is a weight for each factor; and
NXᵢ is the normalized value of each factor.

The display unit 608, may be communicatively coupled with the receiver 602. The display unit may be configured to display the calculated route on a computing system. The receiver 602, may be further configured to receive a response to the calculated one or more routes. The response to the calculated one or more routes may be a selection of the calculated one or more routes. The receiver 602 may be further configured to present a list of route options based on the response to the calculated one or more routes. The list of route options may be one or more, but not limited to airways, roadways, rail networks and/or sea routes. The receiver 602 may be further configured to collect a response to the list of route options. The display unit 608 may be further configured to display a result of the response to the list of route options. The result may be, but not limited to transit charge of selected route, expected delivery date, and payment information of the freight transit. The updated 610 may be configured to update a learning engine based on the received input and the collected response.

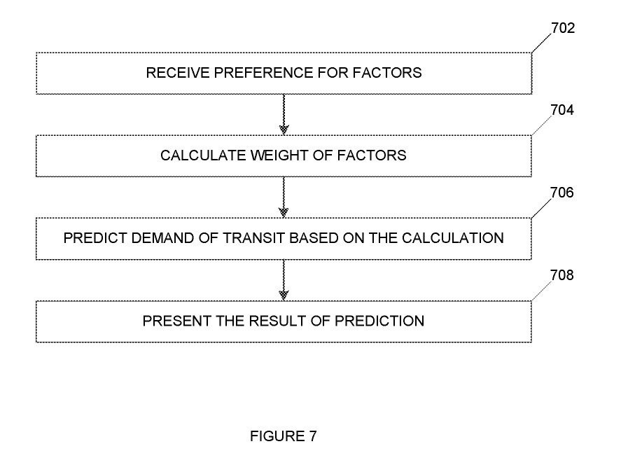

FIG. 7 is a process flow diagram, illustrating a method for predicting demand in a system for freight management. One or more preferences of one or more factors may be received from a user and/or a planner, as in step 702. The one or more factors may be, but not limited to availability of different modes of transport, demand for freight, traffic in one or more transit networks, cost effectiveness, shortage of containers, dead movement of one or more empty containers and/or availability of different resources. A weight of the one or more factors may be calculated, as in step 704. The weight of the one or more factors may be calculated using a decision model. One or more multi-criteria decision-making models (MCDM) may be employed in quantifying the weight of the factor(s). In the present embodiment, analytical hierarchy process (AHP) may be used as one of the MCDM models. The MCDM model may receive relative preferences received from the planner as an input. The relative preferences may be used to arrive at the weight of the factors. Demand of transit may be predicted based on the calculation in the step 704, as in step 706. The demand predicted in step 704 may be presented to the user and/or planner, as in step 708.

FIG. 8 is a block diagram, illustrating various modules constituting an analytical engine of a system for freight management, according to one or more embodiments. The analytical engine 800 may include, an optimizer 802, a preference module 804, a data miner 806, a simulator 808, a forecaster 810 and a statistical module 812. The optimizer 802, may be communicatively coupled with the preference module 804, the data miner 806, the simulator 808, the forecaster 810 and the statistical module 812. The optimizer 802 may be configured to store one or more algorithms. The one or more algorithms stored may be, but not limited to mathematical solvers to solve one or more linear programming problems, integer programming problems, mixed-integer programming problems, constraint programming problems, conic programming problems, problem-specific heuristic algorithms, and/or meta-heuristics algorithms such as tab search, genetic algorithms, and simulated annealing. The one or more algorithms may be used to arrive at optimal or near optimal solution for problems.

In one or more embodiments, the preference module 804, may be communicatively coupled with the optimizer 802, the data miner 806, the simulator 808, the forecaster 810 and the statistical module 812. The preference module 804 may be configured to perform one or more preference operations. The preference module 804 may be configured to store one or more, but not limited to multi-criteria decision making techniques, algorithms to compute user-choice models, algorithms to compute planner-choice models, algorithms that enable collaborative planning, and/or tools to present visualization charts.

In one or more embodiments, the data miner 806 may be communicatively coupled with the optimizer 802, the preference module 804, and the simulator 808. The data miner 806, may be configured to store one or more classification methods (e.g., Bayesian classifiers, neural networks, and clustering techniques), rule mining methods and anomaly detection engine. The data miner 806 may further include recommendation engine.

In one or more embodiments, the simulator 808 may be communicatively coupled with the optimizer 802, the preference module 804, the data miner 806, and the forecaster 810. The simulator 808 may perform what-if analysis. The simulator 808 may be configured to simulate one or more systems, but not limited to deterministic systems, stochastic systems, discrete systems, continuous systems, static systems, and/or dynamic systems.

In one or more embodiments, the forecaster 810 may be communicatively coupled with the optimizer 802, the data miner 806, the simulator 808, and the statistical module 812. The forecaster 810 may be configured to use one or more techniques hosted in the statistical module 812 and/or the data miner 806 to forecast demand accurately. The demand may be forecasted based on one or more techniques, but not limited to moving average methods, exponential smoothing techniques, Autoregressive Moving Average (ARMA) models, Autoregressive Integrated Moving Average (ARIMA) models, Seasonal Autoregressive Integrated Moving Average (SARIMA) models, linear and non-linear regression models, neural networks, and/or Bayesian networks. The ARMA model is a forecasting model (process). In the ARIMA model, both an auto-regression analysis and a moving average method(s) are applied to a well-behaved time series data. The ARIMA model is a generalization of the ARMA model. The ARIMA model may represent a wide range of time series data, and may be generally used in computing probability of a future value lying between any two time limits. The SARIMA model is an extension of the ARMA model. The SARIMA model considers a seasonal behavior for calculation. The forecaster 810 may be further configured to store one or more algorithms to pre-process data, handling missing data, and trend removal.

In one or more embodiments, the statistical module 812 may be communicatively coupled with the optimizer 802, the preference module 804, and the forecaster 810. The statistical module may be configured to host one or more methods to arrive at a descriptive information of a data. The statistical module 812 may be further configured to perform statistical analysis (e.g., to forecast, testing hypothesis) using advanced multi-variant statistical models, and drawing inference from an output. The statistical module 802 may be configured to have the capability of using techniques such as, but not limited to moving average methods, exponential smoothing techniques, Autoregressive Moving Average (ARMA) model, Autoregressive Integrated Moving Average (ARIMA) model, Seasonal Autoregressive Integrated Moving Average (SARIMA) model, linear and non-linear regression models, parametric and non-parametric testing methods for statistical analysis of the data.

In one or more embodiments, the statistical module 812 may be communicatively coupled to the preference module 804. The preference module 804 may supply preferences of various users to the statistical module 812. The preference module 804 may receive data with respect to preferences of the various users from the data miner 806. The preference module 804 may send the preferences to the optimizer 802 in order to receive optimized preferences from the optimizer 802. The statistical module 812 may send a statistically analyzed data to the optimizer 802. The data miner 806 may be communicatively coupled to multiple input and storage devices. The optimizer 802 may receive the data from the data miner for optimization of the data. Further, data miner 806 may detect anomalies through an anomaly detection engine.

In one or more embodiments, the preference module 804 may supply the preferences to the simulator 808. The simulator 808 may send a simulated data to the data miner 806 for detection of anomalies. The simulator 808 may send the simulated data to the forecaster 810. The simulator may send the simulated data to the optimizer to receive optimized simulated data. The forecaster 810 may receive the preferences of the various users from the preference module 804. The statistical module 812 may perform statistical analysis of a forecasted demand received though the forecaster 810. The forecaster 810 may send a forecast data to the optimizer 802.

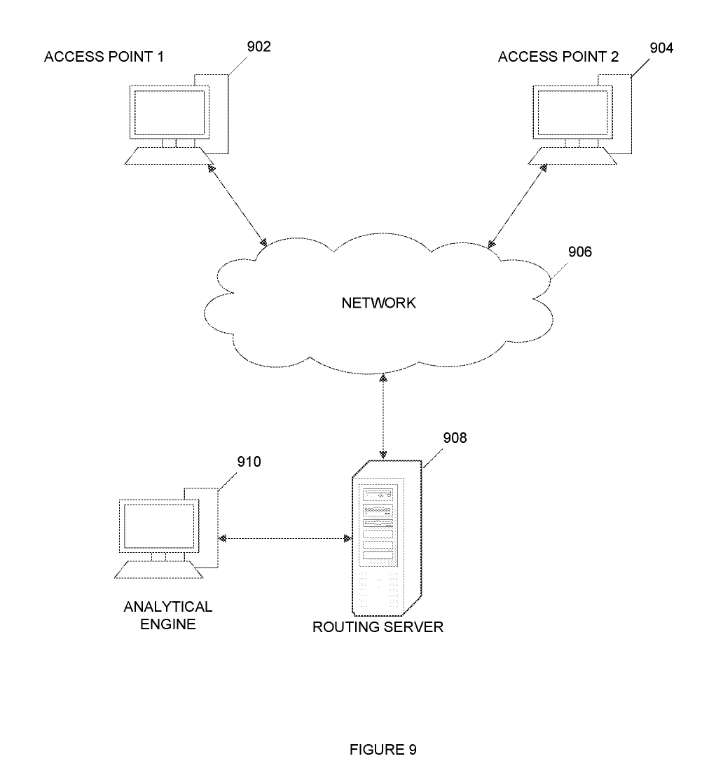

FIG. 9 is a block diagram, illustrating a connectivity of various modules of a system for freight management, according to one or more embodiments. The system may include an access-point1 902, an access-point2 904, a network 906, a routing server 908, and an analytical engine 940. The routing server 908 may be communicatively coupled with the access-point1 902 and the access-point2 904 through the network 906. The routing server 908 may be further communicatively coupled with the analytical engine 910. The access-point1 902, may be configured to receive an input from a user and render output to the user. The access-point2 904 may be configured to receive input from a planner and render output to the planner. The input from the user may be, but not limited to one or more of: user profiles, user preferences, an origin location, a destination location for the shipment, a date of shipment, a desirable delivery date, preferred service providers, types of container required, safety constraints, transit constraints, cost constraints, service quality constraints, and/or number of possible routes between the source location and the destination location.

The analytical engine 910 may extract user data from a user database. The user database may be configured to store information of various users across globe. The analytical engine 910 may calculate one or more routes by referring to a network database. The network database may be configured to store a freight transit route information. The freight transit route information may be, but not limited to information of one or more of: road networks, sea networks, rail networks, airway networks, details of loading and unloading locations, list of origin and destination (OD) pairs, types of service available, list of service providers, distance between OD pair, service available between OD pair, cost of transportation between OD pair, tax and regulations of OD pair, and/or availability of facilities at different locations.

Based on constraints and factors entered by the user, one or more routes for freight transit may be generated by the analytical engine 910. The process of generation of the one or more routes may include calculating and assigning weight to the factors. The weights may be calculated using multi-criteria decision-making models (MCDM). In the present embodiment, analytical hierarchy process (AHP) may be used as one of the MCDM models. The MCDM model may use a relative preference received from various planners over the factors. The relative preference may be used to arrive at the weight of the factors. One or more routes may be calculated using a weighted objective function. The calculated one or more routes may be presented to the user through access-point1 902. The user may select a route from the one or more routes. Based on the selected route, a list of route options may be presented to the user. The list of route options may be one or more airways, roadways, rail routes and/or sea routes.

The user may select a route option in the list of route options. The result may be presented to the user based on the selection of the route option. The result may be, but not limited to display of transit charge of the selected route, expected delivery date, and payment information. The user may perform what-if analysis through access-point1 902 by selecting various parameters to evaluate impact of the parameters. The access-point1 902, may be further configured to receive feedback from the user. The received feedback may be used to update a learning engine.

The access-point2 904 may be configured to receive input from the planner. The planner may evaluate service providers and/or users based on a set of criterion. The received input through access-point2 904 may be, but not limited to selection of a freight transit order placed by a user, planner profiles, planner preferences, demand forecast for origin and destination pair, planning horizon, collaborative planning data and comments, number of possible routes, and feedback about the routes and/or forecast. The analytical engine 910 may calculate a weight of one or more factor considered by the planner. The weight may be calculated using multi-criteria decision-making models (MCDM). An analytical hierarchy process (AHP) may be applied as one of the MCDM models to calculate the weight of the one or more factors. The MCDM model may use relative preference received from various planners over the one or more factors. The relative preference may be used to arrive at the weight of the one or more factors.

The analytical engine 910, may forecast a demand for the planning horizon. The planning horizon may be yearly, half-yearly, quarterly, monthly, and/or weekly. The demand may be presented to the planner through the access-point2 904. The access-point2 904 may be configured to perform what-if analysis by considering one or more parameters to evaluate impact of the one or more parameters. The access-point2 904 may be further configured to receive feedback from the planner to update a learning engine.

In an example embodiment, factors such as cost of transit, quality of service, timeliness and time constraint may be considered by a user. Consider W₁ to be a weight of the cost of transit, W₂ to a weight of the quality of service, W₃ to be a weight of the timeliness, and W₄ to be a weight of the time constraint. Analytical hierarch process (AHP) technique may be applied to calculate the weight of the factors. After the calculation, the weight of each factor may be:
W₁=0.2;
W₂=0.13;
W₃=0.32; and
W₄=0.35;
   The route between a source location and a destination location of a freight transit may be calculated using a weight function:

$$Z = {\sum }_{i = 1}^{I} {W}_{i} \times {NX}_{i}$$

where,
Z is a weighted objective function;
I is a number of factors;
Wᵢ is a weight for each factor; and
NXᵢ is the normalized value of the each factor.

There may be two possible routes, route1 and route2 between the source location and the destination location of the freight transit. Values of Z₁ and Z₂ may be calculated to arrive at best route between the source and the destination of the freight transit. For the route1, value of Xᵢ may be:
X₁=500;
X₂=6;
X₃=8; and
X₄=6;
   For the route2, value of Xᵢ may be:
X₁=300;
X₂=4;
X₃=4; and
X₄=3;
   The values of X₁, X₂, X₃, and X₄ may be normalized as represented in a table below.

TABLE 1

| Route | | Normalized | | Normalized | | Normalized | | Normalized |
|---|---|---|---|---|---|---|---|---|
| No. | X1 | X1 (N X1) | X2 | X1 (N X2) | X3 | X1 (N X3) | X4 | X1 (N X4) |
| 1 | 500 | 500/800 = | 6 | 6/10 = | 8 | 8/12 = | 6 | 6/9 = |
| | | 0.625 | | 0.6 | | 0.67 | | 0.67 |
| 2 | 300 | 300/800 = | 4 | 4/10 = | 4 | 4/12 = | 3 | 3/9 = |
| | | 0.375 | | 0.4 | | 0.33 | | 0.33 |
| | Sum = 800 | | 10 | | 12 | | 9 | |

The value of Z₁ for the route1 may be calculated as:

Z₁=0.2×0.625+0.13×0.6+0.32×0.67+0.35×0.67

Z₁=0.65

The value of Z₂ for the route2 may be calculated as:

Z₂=0.2×0.375+0.13×0.4+0.32×0.33+0.35×0.33

Z₂=0.35

Maximum value of Z₁ and Z₂ may be calculated as:

Max(0.65,0.35)=0.65

Hence, the route1 may be suggested to the user.

In an exemplary embodiment, a planner may hypothetically play a role of a user in order to manage freight through the freight management system. Thus, the planner may realize an increased efficiency in management of the freight through the freight management system.

In one or more embodiments, the freight management system may enable collaborative planning by one or more planners. The collaborative planning may help a planner to take tactical and/or operational decisions based on different information factors available. For a route, one or more preferences of a user, a service provider and the planner, may be captured quantitatively. A feedback obtained from the user and the planner may be provided to a learning engine to update the learning engine. Various type of models may be used to solve complex freight management problems in a logistic service network. Therefore, an operational efficiency of the freight management system is improved.

In one or more embodiments, the freight management system may also enable tracking of freight (shipment), through real-time radio frequency identification (RFID) tracking and/or global positioning system (GPS). A user, a planner and/or a service provider may track the freight through RFID and/or GPS. The RFID is a system for fetching automated data based on tagging items. The RFID system may be based on active tags or passive tags. The active tags are equipped with self-powered or battery on tags. The passive tags may be read with a help of electric field generated by an antenna (reader). The freight may be equipped with RFID system. Thus, the freight may be tracked during a freight transit. The RFID of the freight may be handled automatically and/or manually. The freight management system may send regular updates to one of the user, the service provider and/or planner in order to track the freight. The service provider may get confirmation on safe delivery of the freight to the user (customer). The planner may track the freight and plan accordingly, in order to make an efficient use of one or more resources.

A container may be equipped with GPS tracker to get a location information and/or route information of the freight. A person carrying the container may also be equipped with GPS enabled devices. The RFID and GPS information may be considered together for better management of the freight transit. The GPS systems may help the planner and/or the service provider to get the location information and/or the route information of the freight transit.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

1. A computer implemented method for freight management comprising:
receiving, by a processor, an input request for freight transit;
matching, by a processor, the input request with a network database (202);
calculating, by a processor, a route in response to the matching;
displaying, by a processor, the calculated route on the computer system;
receiving, by a processor, an input through a computing device in response to the displayed route;
presenting, by a processor, a list of route options based on the input, and collecting at least one response to the list of route options;
displaying a result of the at least one response on the route options; and
updating, by a processor, a learning engine based on the received input and collected response.

2. The method of claim 1, wherein the network database (202) is configured to store freight transit route information.

3. The method of claim 1, wherein the input request for freight transit is at least one of a freight information and a location information.

4. The method of claim 1, wherein the calculated route in response to the matching is at least one route between source location and delivery location of the freight transit.

5. The method of claim 1, wherein the input in response to the calculated route is a selection of the calculated route.

6. The method of claim 1, wherein the list of route options is at least one of an airway, a roadway, a rail route and sea route.

7. The method of claim 1, wherein the result is at least one of transit charge of the selected route, expected delivery date and payment information.

8. The method of claim 2, wherein the freight transit route information is one of a road network, a sea network, a rail network and an airway network.

9. A system for freight management comprising:
a computer network;
a route mapping server associated with the computer network;
a processor in operable communication with a computer readable storage medium, the computer readable storage medium containing one or more programming instructions whereby the processor is configured to implement:
a receiver module configured to receive an input request for a freight transit;
a mapper module configured to map the input request with a network database;
a calculator module configured to calculate a route in response to the mapping;
a display unit communicatively coupled to the receiver, configured to display the calculated route on the computer system,
wherein the receiver module is configured receive a response to the calculated route,
wherein the receiver module is configured to present a list of route options based on input,
wherein at least one response to the list of route options is collected through the receiver module and
wherein the display unit is configured to display a result of the at least one response on the route options; and
an updater ( ), configured to update, a learning engine based on the received input and collected response.

10. The system ( ) of claim 9, wherein the route mapping server ( ) is configured to handle freight transit requests.

11. The system ( ) of claim 9, wherein the input request for freight transit is at least a freight information and a location information.

12. The system of claim 9, wherein the network database ( ) is configured to store freight transit route information.

13. The system of claim 9, wherein the calculated route in response to the matching is at least one route between a source location and a delivery location of the freight transit.

14. The system of claim 9, wherein the response to the calculated route is a selection of the calculated route.

15. The system of claim 9, wherein the list of route options is at least one of an airway, a roadway, a rail route and a sea route.

16. The system of claim 9, wherein the result is at least one of a transit charge of selected route, expected delivery date and payment information.

17. The system of claim 12, wherein the freight transit route information is one of a road network, a sea network, a rail network and an airway network.

18. A computer implemented method for freight management comprising:
receiving, by a processor, a preference of factors;
calculating, by a processor, a weight of factors;
predicting, by a processor, a demand of transit based on the calculation; and
presenting, by a processor, a result of the prediction.

19. The method of claim 18, wherein the factors comprise at least one of cost of transit, quality of service, and time constraint.

20. The method of claim 18, wherein the weights are calculated using a decision model.

21. The method of claim 1 wherein the route is calculated using a weighted function represented as:
Z=Σᵢ₌₁^{I}Wᵢ×NXᵢ
where,
Z is a weighted objective function;
I is a number of factors;
W_i is a weight for each factor; and
NX_i is the normalized value of each factor.

22. The system of claim 9 wherein the route is calculated using a weighted function represented as:
Z=Σᵢ₌₁^{I}Wᵢ×NXᵢ
where,
Z is a weighted objective function;
I is a number of factors;
W_i is a weight for each factor; and
NX_i is the normalized value of each factor.
